(19) United States
(12) Patent Application Publication
(10) Pub. No.: US 2015/0321047 A1
(43) Pub. Date: Nov. 12, 2015

(54) SYSTEMS AND METHODS FOR A GROUNDED COVERING THAT IS IN DIRECT CONTACT WITH A NATURAL EARTH GROUND

(71) Applicant: Sharon Whiteley, Rhinebeck, NY (US)

(72) Inventor: Sharon Whiteley, Rhinebeck, NY (US)

(21) Appl. No.: 14/689,856

(22) Filed: Apr. 17, 2015

Related U.S. Application Data
(60) Provisional application No. 61/980,780, filed on Apr. 17, 2014.

(51) Int. Cl. A63B 21/00; H05F 3/02; A47G 9/06

(52) U.S. Cl. CPC A63B 21/1473; A47G 9/062; H05F 3/02

(57) ABSTRACT

Systems and methods for a grounded covering that is in direct contact with a natural earth ground are provided. In some embodiments, a mat is provided, the mat comprising: a first material forming a substantially planar form; and at least one conductive material integrated into the first material in a manner in which the at least one conductive material conducts electricity from a first side of the first material to a second side of the first material, and in which the at least one conductive material is visible to a user and arranged to contact one or more exposed body parts of a user while the user is performing yoga poses on the first material.

### CROSS-REFERENCE TO RELATED APPLICATION

This application claims the benefit of U.S. Provisional Patent Application No. 61/980,780, filed Apr. 17, 2014, which is hereby incorporated by reference herein in its entirety.

### TECHNICAL FIELD

The disclosed subject matter relates to systems and methods for a grounded covering that is in direct contact with a natural earth ground.

### BACKGROUND

“Grounding” is a process through which a person is connected electrically to an Earth ground, such as soil. Grounding is known to provide various health benefits.

It is desirable to provide new mechanisms to facilitate grounding of people.

### SUMMARY

Systems and methods for a grounded covering that is in direct contact with a natural earth ground are provided. In some embodiments, a mat is provided, the mat comprising: a first material forming a substantially planar form; and at least one conductive material integrated into the first material in a manner in which the at least one conductive material conducts electricity from a first side of the first material to a second side of the first material, and in which the at least one conductive material is visible to a user and arranged to contact one or more exposed body parts of a user while the user is performing yoga poses on the first material.

### BRIEF DESCRIPTION OF THE DRAWINGS

FIG. 1 is an illustration of a grounded covering in accordance with some embodiments.

FIG. 2 is an illustration of another grounded covering in accordance with some embodiments.

FIG. 3 is an illustration of still another grounded covering in accordance with some embodiments.

FIG. 4 is an illustration of yet another grounded covering in accordance with some embodiments.

### DETAILED DESCRIPTION

In accordance with various implementations, mechanisms (which can include systems and methods) for a grounded covering for use on grass, dirt, or any other suitable outside surface that is coupled to a natural earth ground in some embodiments are provided.

In some implementations, the described mechanisms can be used to provide any suitable type of grounded covering. For example, the covering can include any suitable covering such as a yoga mat, an exercise mat, a towel, a beach towel, a picnic cloth, a blanket, a beach blanket, a pillow, a sheet, and/or any other suitable covering.

In some embodiments, the covering can allow for a complete flow of electrons between a ground (e.g., grass, dirt, a grounded floor, a grounded carpet, a surface of the Earth, etc.) and a user's body (e.g., a user's hands, a user's feet, a user's back, a user's knees, a user's elbows, a user's chest, etc.). The mechanisms of the covering can maintain conductive contact with the ground and the user's body using any suitable technique or techniques. For example, the covering can incorporate an electrically conductive thread throughout the covering. In such an example, the conducive thread can contact both sides of the covering to maintain a consistent flow of electrons between the ground and the user's body.

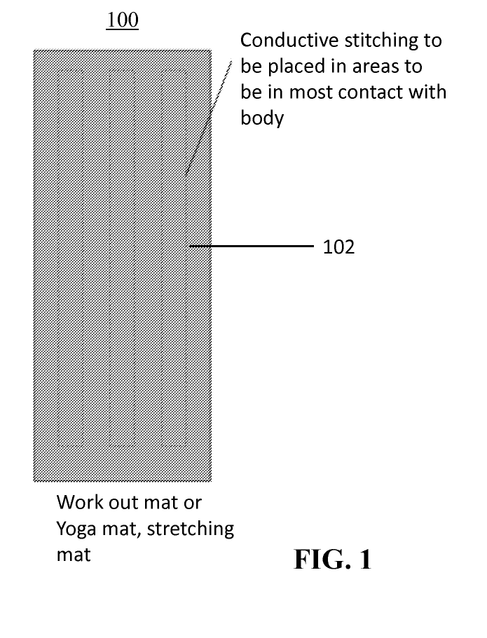

FIG. 1 shows an example of a mat in accordance with some embodiments of the disclosed subject matter. As illustrated, a mat 100 can be made of any suitable nonconductive material. For example, mat 100 can be made of any suitable thermoplastic, thermoplastic elastomer, bamboo, polyvinyl chloride (PVC), wood, fiberglass, Kevlar, and/or any suitable material. In some embodiments, mat 100 can be any suitable structure, such as a non-slip mat, a rollable mat, a non-rollable mat, a water resistant mat, and/or any other suitable mat. In some embodiments, mat 100 can be any suitable shape, such as a rectangle, a square, a circle, a triangle, and/or any other suitable shape.

In some embodiments, as illustrated, a mat 100 can include a thread 102. In some embodiments, thread 102 can be made out of any suitable electrically conductive material, such as a conductive rubber, a conductive plastic, a conductive thermoplastic, a conductive foam, a conductive fabric, a conductive cloth, a conductive carbon fiber, a conductive leather, a conductive polymer, a conductive resin, and/or any other suitable conductive material. The conductive material can contain any suitable conductive metal, such as carbon, aluminum, tinned cooper, stainless steel, brass, a silver alloy, and/or any other suitable electrical conductive metal.

In some embodiments, thread 102 can be visible to a user. For example, thread 102 can be any suitable color. In a more particular example, thread 102 can be a bright color, such as a bright blue, a bright red, a bright orange, a bright yellow, and/or any other suitable color. In another more particular example, thread 102 can be a contrasting color from mat 100. In another more particular example, thread 102 can be a similar color to mat 100.

In some embodiments, thread 102 can be elevated from mat 100. For example, thread 102 can be slightly elevated from mat 100. In such an example, thread 102 can be felt by a user's hand and/or foot (e.g., when a user is not looking towards the covering).

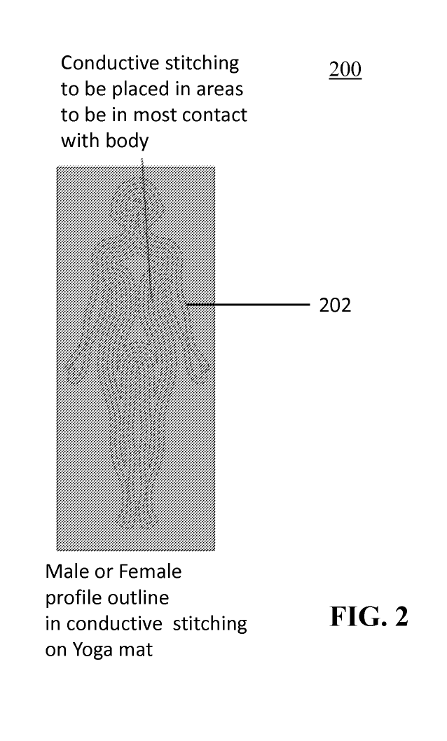

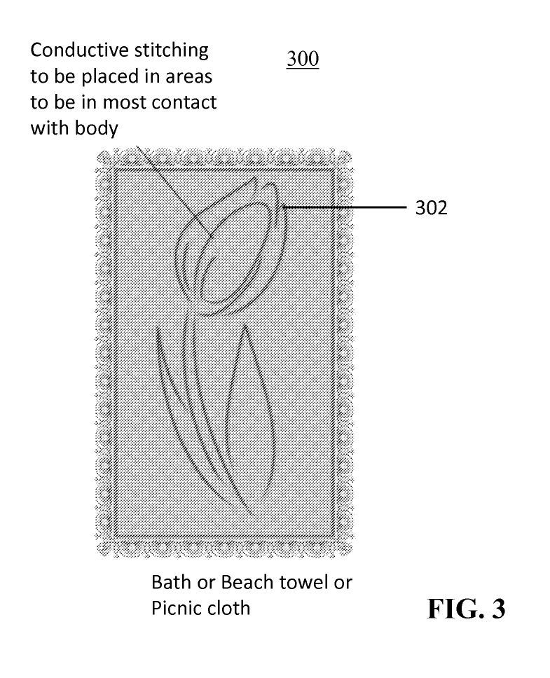

Thread 102 can be stitched in any suitable manner to indicate to a user where to place a particular body part. For example, thread 102 can be stitched into any suitable shape (e.g., a square, a rectangle, a triangle, a circle, etc.), any suitable combination of shapes, any suitable pattern, any suitable design, and/or any other suitable stitching. In a more particular example, as shown in FIG. 1, thread 102 can be stitched into three parallel rectangles. In another particular example, as shown in FIG. 2, thread 202 can be stitched into the shape of a body. In yet another particular example, as shown in FIG. 3, thread 302 can be stitched into the shape of a flower. In some embodiments, thread 102 can be stitched into a hand and/or a foot to indicate to a user where to place his or her hands and/or feet. Additionally and/or alternatively, thread 102 can be stitched into a circle to indicate to a user where to place his or her knees and/or elbows.

In some embodiments, thread 102 can allow electrons to flow between the ground (e.g., a floor, a carpet, a dirt, etc.) and a user touching thread 102. For example, the electrons can flow between the ground and the user's hand and feet (e.g., when a user is doing a particular yoga stance involving a user hands and/or feet). In another example, the electrons can flow between the ground and the user's back (e.g., when a user is lying down on a yoga mat). In yet another example, the electrons can flow between the ground and the user's lower body (e.g., when a user is sitting on a yoga mat).

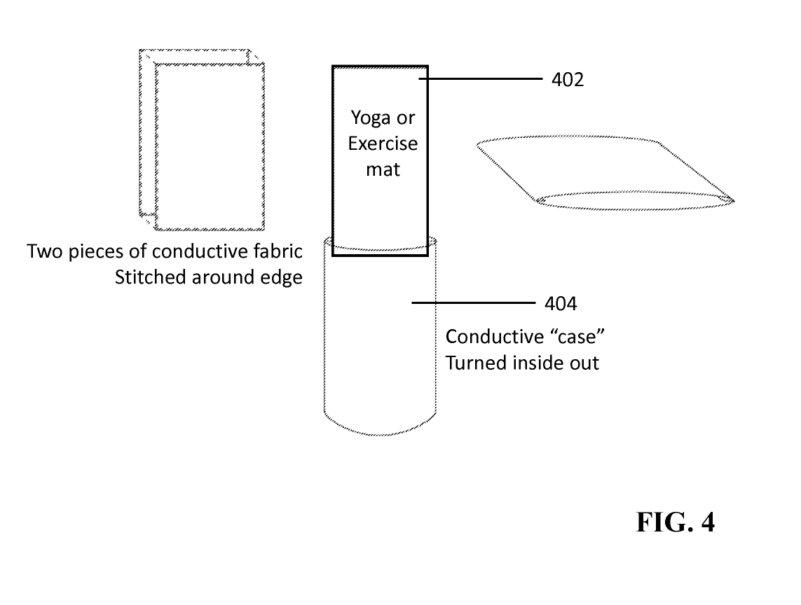

FIG. 4 shows an example of an exercise mat cover in accordance with some embodiments of the disclosed subject matter. As illustrated, a mat 402 can be covered by a case 404. In some embodiments, case 404 can be made out of any suitable electrically conductive material, such as a conductive rubber, a conductive plastic, a conductive thermoplastic, a conductive foam, a conductive fabric, a conductive cloth, a conductive carbon fiber, a conductive leather, a conductive polymer, a conductive resin, and/or any other suitable conductive material. The conductive material can contain any suitable conductive metal, such as carbon, aluminum, tinned cooper, stainless steel, brass, a silver alloy, and/or any other suitable electrical conductive metal. In some embodiments, case 404 can include a first conductive fabric and a second conductive fabric that can be stitched together. For example, the first conductive fabric and the second conductive fabric can be stitched together around each of their respective edges.

In some embodiments, case 404 can cover any suitable exercise mat and/or yoga mat. For example, a user can cover a nonconductive yoga mat with case 404. In such an example, case 404 can allow electrons to flow between the ground (e.g., a floor, a carpet, a dirt, etc.) and a user touching case (e.g., when a user is doing a particular yoga position).

In some embodiments, the covering can include a conductive wire. The conductive wire can be made of any suitable electrically conductive metal material, such as copper, aluminum, tinned copper, stainless steel, silver, and/or any suitable conductive metal material. Additionally, the conductive wire can be any suitable structure, such as a solid wire, a stranded wire, a braided wire, and/or any other suitable structure. In some embodiments, the conducive wire can be placed inside any suitable covering to allow for the flow of electrons between the ground and the user's body.

Although some of the figures have been illustrated as a mat, it is understood that the covering can be any suitable covering, such as a yoga mat, an exercise mat, a towel, a beach towel, a picnic cloth, a blanket, a beach blanket, a pillow, a sheet, and/or any other suitable covering.

Although the invention has been described and illustrated in the foregoing illustrative embodiments, it is understood that the present disclosure has been made only by way of example, and that numerous changes in the details of embodiment of the invention can be made without departing from the spirit and scope of the invention. Features of the disclosed embodiments can be combined and rearranged in various ways.

What is claimed is:

1. A mat, comprising:
a first material forming a substantially planar form; and
at least one conductive material integrated into the first material in a manner in which the at least one conductive material conducts electricity from a first side of the first material to a second side of the first material, and in which the at least one conductive material is visible to a user and arranged to contact one or more exposed body parts of a user while the user is performing yoga poses on the first material.
